(19) United States
(12) Patent Application Publication
(10) Pub. No.: US 2025/0298301 A1
(43) Pub. Date: Sep. 25, 2025

(54) PROJECTION SYSTEM AND ELECTRONIC DEVICE

(71) Applicant: GOERTEK OPTICAL TECHNOLOGY CO., LTD, Shandong (CN)

(72) Inventors: Junwei LIN, Shandong (CN); Dianliang XIE, Shandong (CN); Guiyu LI, Shandong (CN); Yaling XU, Shandong (CN)

(21) Appl. No.: 18/860,744

(22) PCT Filed: Jun. 28, 2022
(86) PCT No.: PCT/CN2022/101980

§ 371 Date: Oct. 28, 2024

(30) Foreign Application Priority Data
Apr. 28, 2022 (CN) 202210469768.8

(51) Int. Cl. G03B 21/20

(52) U.S. Cl. CPC G03B 21/2066; G03B 21/2073; G03B 21/208

(57) ABSTRACT

The present disclosure provides a projection system and an electronic device. The projection system includes a light source assembly, an imaging assembly, and a reflective component; the imaging assembly includes a first lens located near an exit pupil of the imaging assembly; the first lens has a first part and a second part, the first part and the second part being separated by an optical axis; the light source assembly is configured to emit rays. among which least a chief emitted ray is incident through the first part of the first lens, and is then reflected by the reflective component to form reflection rays, among which at least a chief reflection ray is emergent through the second part of the first lens.

### CROSS-REFERENCE TO RELATED APPLICATIONS

The present disclosure is a National Stage of International Application No. PCT/CN2022/101980, filed on Jun. 28, 2022, which claims priority to a Chinese patent application No. 202210469768.8 filed with the CNIPA on Apr. 28, 2022, both of which are hereby incorporated by reference in their entireties.

### TECHNICAL FIELD

The present disclosure relates to the technical field of projection, and particularly to a projection system and an electronic device.

### BACKGROUND

With the use of polarized beam-splitting display technology in conjunction with LED light sources, polarized beam-splitting projectors are becoming increasingly smaller in size and are gradually developing into portable micro-projectors.

The polarized beam-splitting projectors may be used with LCOS displays, which utilize polarized light. Therefore, most of the polarized beam-splitting projectors need to use a glass PBS prism system; however, the glass PBS prism, to ensure improved performance, generally made of expensive Schottky SF57 material, which is disadvantageous in terms of cost. Now some manufacturers are also actively developing very inexpensive plastic PBS films for use in the projectors, which reduces the cost of the PBS prism system. However, since the lighting and imaging systems are designed separately from each other in the polarized beam-splitting projectors, and the necessary element for separating the optical paths of the two systems is a polarization mechanism, which directly leads to the inability to further reduce the size of the projectors.

### SUMMARY

An objective of the present disclosure is to provide a new technical solution for a projection system and an electronic device.

According to a first aspect of embodiments of the present disclosure, a projection system is provided, which includes a light source assembly, an imaging assembly, and a reflective component;
the imaging assembly includes a first lens located near an exit pupil of the imaging assembly; the first lens has a first part and a second part, the first part and the second part being separated by an optical axis;
at least a chief ray among rays emitted by the light source assembly is incident through the first part of the first lens, and is then reflected by the reflective component to form reflection rays, among which at least a chief reflection ray is emergent through the second part of the first lens.

Optionally, the projection system includes a lighting system and an imaging system; the light source assembly and the imaging assembly constitute the lighting system, and the reflective component and the imaging assembly constitute the imaging system; F/# of the lighting system is 0.45 to 0.55 times that of the projection system.

Optionally, the chief ray is transmitted from the first part of the first lens to the reflective component to form a first optical path; the chief reflection ray is transmitted from the reflective component to the second part of the first lens to form a second optical path; the first optical path and the second optical path are arranged non-coaxially.

Optionally, the first part and the second part of the first lens have unequal curvature radii.

Optionally, the chief ray is transmitted from the first part of the first lens to the reflective component to form a lighting optical path, and the chief reflection ray is transmitted from the reflective component to the second part of the first lens to form an imaging optical path;

when the first optical path has an optical path length shorter than that of the second optical path, the first part of the first lens has a curvature radius smaller than that of the second part of the first lens.

Optionally, the imaging assembly includes a lens group arranged along the optical axis, which includes the first lens.

Optionally, the light source assembly includes a light source group and a light combining group, rays emitted from the light source group are transmitted to the ray combining group, and the light combining group transmits received rays to the first part of the first lens.

Optionally, the light combining group includes a compound parabolic concentrator and a light waveguide, and the light waveguide is located on a light-emergent side of the compound parabolic concentrator; or, the light combining group includes a total internal reflection lens and a light waveguide, and the light waveguide is located on a light-emergent side of the total internal reflection lens.

Optionally, the light combining group includes three compound parabolic concentrators arranged in different horizontal planes or three total internal reflection lenses arranged in different horizontal planes; and light waveguides corresponding one-to-one with the three compound parabolic concentrators or the three total internal reflection lenses have unequal lengths.

Optionally, the light combining group includes three compound parabolic concentrators arranged in the same horizontal plane or three total internal reflection lenses arranged in the same horizontal plane; and light waveguides corresponding one-to-one with the three compound parabolic concentrators or the three total internal reflection lenses have equal lengths.

According to a second aspect of embodiments of the present disclosure, an electronic device is provided, which includes the projection system of the first aspect.

The other features and advantages of the present disclosure will become clear through the following detailed description of exemplary embodiments with reference to the accompanying drawings.

### BRIEF DESCRIPTION OF THE DRAWINGS

In order to clearly illustrate embodiments of the present disclosure or technical solutions in the prior art, accompanying drawings that need to be used in description of the embodiments or the prior art will be briefly introduced as follows. Obviously, drawings in following description are only the embodiments of the present disclosure. For those skilled in the art, other drawings can also be obtained according to the disclosed drawings without creative efforts.

FIG. 1 illustrates a structural schematic diagram I of an imaging assembly.

FIG. 2 illustrates a structural schematic diagram I of a projection system.

FIG. 3 illustrates a structural schematic diagram II of the projection system.

FIG. 4 illustrates a structural schematic diagram III of the projection system.

FIG. 5 illustrates a structural schematic diagram IV of the projection system.

FIG. 6 illustrates a structural schematic diagram II of the imaging assembly.

FIG. 7 illustrates a structural schematic diagram of a projection system in the prior art.

### DESCRIPTION OF REFERENCE SIGNS

1. light source assembly; 11. light source group; 12. light combining group; 121. collimator; 122. light waveguide; 123. compound parabolic concentrator; 124. total internal reflection lens; 125. dichroic mirror;

2. imaging assembly; 21. first lens; 22. second lens; 23. third lens; 24. fourth lens; 211. first part; 212. second part;

3. reflective component.

### DETAILED DESCRIPTION

Various exemplary embodiments of the present disclosure will now be described in detail with reference to the accompanying drawings. It is to be noted that unless otherwise specified, the scope of present disclosure is not limited to relative arrangements, numerical expressions and values of components and steps as illustrated in the embodiments.

Description to at least one exemplary embodiment is for illustrative purpose only, and in no way implies any restriction on the present disclosure or application or use thereof.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Different values may be available for alternative examples of the exemplary embodiments.

It is to be noted that similar reference numbers and alphabetical letters represent similar items in the accompanying drawings. In the case that a certain item is identified in a drawing, further reference thereof may be omitted in the subsequent drawings.

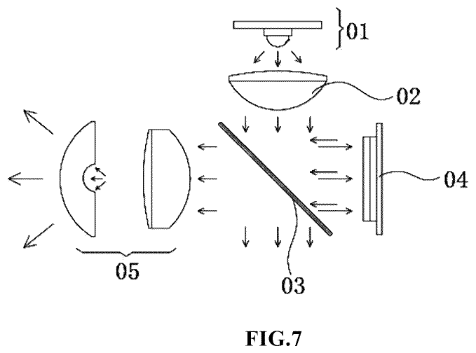

Referring to FIG. 7, the projector in the prior art includes a light source system 01, a light condensing mechanism 02, a polarization mechanism 03, an LCOS display system 04, and an imaging optical path system 05. Wherein, a lighting optical path is constituted by the light source system 01, the light condensing mechanism 02 and the polarization mechanism 03, which are sequentially arranged and whose center points are collinear; the straight line on which the center points of the light source system 01, the light condensing mechanism 02 and the polarization mechanism 03 are located is a lighting optical axis; an imaging optical path is constituted by the imaging optical path system 05, the polarization mechanism 03, and the LCOS display system 04, which are sequentially arranged and whose center points are collinear; the straight line on which the center points of the imaging optical path system, the polarization mechanism and the LCOS display system are located is an imaging optical axis; and the imaging optical axis is perpendicular to the lighting optical axis. It can be seen that the lighting and imaging systems are designed separately from each other in the present projectors, and the necessary element for separating the optical paths of the lighting and the imaging systems is a polarization mechanism (PBS), which directly leads to the inability to reduce the size of the projectors further.

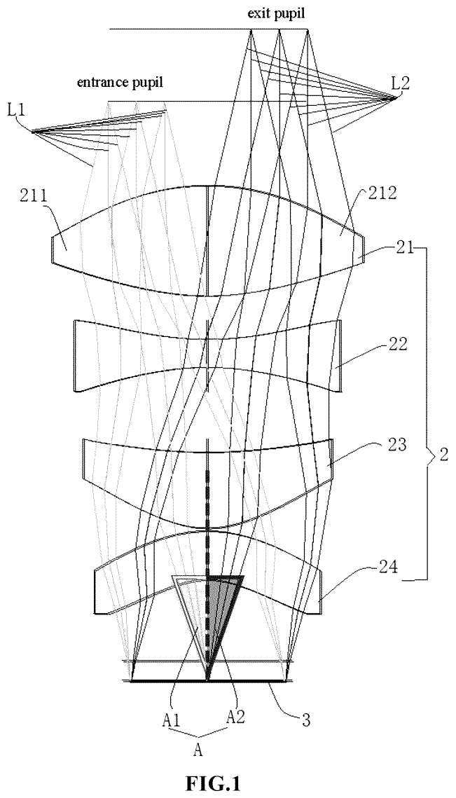

Based on the above technical problem, the present disclosure provides a projection system. Referring to FIGS. 1 to 6, the projection system includes: a light source assembly 1, an imaging assembly 2, and a reflective component 3. The imaging assembly 2 includes a first lens 21 located near an exit pupil of the imaging assembly 2; the first lens 21 has a first part 211 and a second part 212, the first part 211 and the second part 212 being separated by an optical axis; at least a chief ray among rays L1 emitted by the light source assembly 1 is incident through the first part 211 of the first lens 21, and is then reflected by the reflective component 3 to form reflection rays L2, among which at least a chief reflection ray is emergent through the second part 212 of the first lens 21.

In other words, the projection system of the embodiments of the present disclosure only includes the light source assembly 1, the imaging assembly 2, and the reflective component 3. The projection system does not include a polarization mechanism. The rays L1 emitted by the light source assembly 1 are directly transmitted to the imaging assembly 2, transmitted through the imaging assembly 2 to the reflective component 3, and then reflected by the reflective component 3; the reflected reflection ray L2 are emergent after passing through the imaging assembly 2. Thus, in the embodiment, the light source assembly 1 and the imaging assembly 2 constitute the lighting system. The imaging assembly 2 and the reflective component 3 constitute the imaging system. The lighting system and the imaging system share the architecture of the imaging assembly 2.

In the embodiment, the chief ray emitted by the light source assembly 1 is transmitted to the first part 211 of the first lens 21, that is, the entrance pupil of the lighting optical path corresponds to the first part 211 of the first lens 21. The chief ray emitted by the light source assembly 1 enters the imaging assembly 2 through the first part 211 of the first lens 21, is transmitted inside the imaging assembly 2, and is transmitted through the imaging assembly 2 to the reflective component 3. Referring to FIGS. 1 to 6, the first part 211 of the first lens 21 is the left area of the first lens 21; in the lighting optical path, the chief ray emitted by the light source assembly 1 enters the imaging assembly 2 through the left area of the first lens 21 of the imaging assembly 2, and then is transmitted to the reflective component 3 to be reflected by the reflective component 3.

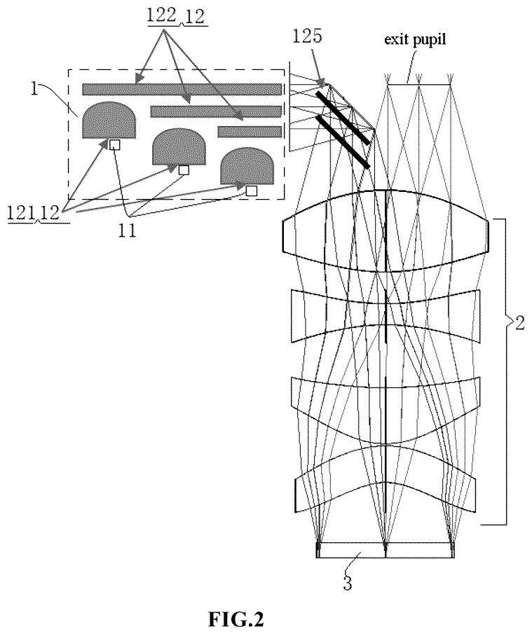

In a specific embodiment, the rays L1 emitted by the light source assembly 1 enter the imaging assembly 2 through the first lens 21 of the imaging assembly 2. Specifically, the rays emitted by the light source assembly 1 include the chief ray and marginal rays. Specifically, referring to FIGS. 1 to 5, the rays L1 emitted by the light source assembly 1 enters the imaging assembly 2 through the left area of the first lens 21 of the imaging assembly 2; referring to FIGS. 2 to 4, the chief ray emitted by the light source assembly 1 enters the imaging assembly 2 through the left area of the first lens 21 of the imaging assembly 2. Therefore, the projection system (lighting system) provided by the embodiment of the present disclosure may enable at least the chief ray to enter the imaging assembly 2 through the left area of the first lens 21 of the imaging assembly 2.

Specifically, the chief ray is a concept known to those skilled in the art, that is, the explanation in Baidu Encyclopedia: the chief beam is the beam of light that is emergent through the edge of the object, passes through the center of the aperture stop, and finally reaches the edge of the image.

In the embodiment, the rays emitted by the light source module are transmitted through the imaging assembly 2 to the reflective component 3, and then reflected by the reflective component 3 to form the reflection ray L2. Here, the reflection ray L2 is the ray carrying the display information. The reflection ray L2 includes the reflection chief ray and the reflection marginal ray. The reflection chief ray, after passing through the second part 212 of the first lens 21 in the transmission process, is emergent and can enter the user's eyes. That is, the exit pupil of the imaging optical path corresponds to the second part 212 of the first lens 21. Referring to FIGS. 1 to 6, the second part 212 of the first lens 21 is the right area of the first lens, and in the imaging optical path, the reflection chief ray formed after being reflected by the reflective component 3 is transmitted by the imaging assembly 2, and finally is emergent through the right area of the first lens 21 of the imaging assembly 2. Alternatively, the first part 211 of the first lens 21 could be the right area of the first lens 21, and the second part 212 of the first lens 21 could be the left area of the first lens 21. The chief ray emitted by the light source assembly 1 is incident through the right area of the first lens 21, and the reflection chief ray formed by being reflected by the reflective component 3 is emergent through the left area of the first lens 21.

In a specific embodiment, the reflection ray L2 formed from reflection by the reflective component 3 are emergent through the first lens 21 of the imaging assembly 2, and enters the human eye. Here, the rays reflected by the reflective component 3 include the reflected chief ray and the reflected marginal ray. Specifically, referring to FIGS. 1 to 5, the reflection ray L2 reflected by the reflective component 3 is emergent through the right area of the first lens 21 of the imaging assembly 2; referring to FIGS. 2 to 4, the reflection chief ray formed by reflection by the reflective component 3 is emergent through the right area of the first lens 21 of the imaging assembly 2. Therefore, the projection system (imaging system) provided by the embodiment of the present disclosure can enable at least the reflected chief ray to be emergent through the right area of the first lens 21 of the imaging assembly 2.

Therefore, in the embodiment of the present disclosure, the provided projection system does not include the polarization mechanism, and thus reduces the volume of the projection system. The lighting optical path and the imaging optical path in the projection system share the imaging assembly 2, the chief ray of the lighting optical path is incident from the first part 211 of the first lens 21, the reflection chief ray of the imaging optical path is emergent from the second part 212 of the first lens 21, thereby enabling the lighting optical axis and the imaging optical axis to be arranged substantially parallel to each other, and thus further reducing the volume of the projection system.

It should be noted that the optical axis is the central axis of the entire structure of the imaging assembly 2.

In an alternative embodiment, the reflective component 3 may be a light valve component. For example, the light valve component is a polarized beam-splitting component. For example, the light valve component includes, but is not limited to, an LCOS display screen, and may also be an LCD display screen.

In one embodiment, referring to FIG. 1, the projection system includes a lighting system and an imaging system; the light source assembly 1 and the imaging assembly 2 constitute the lighting system, and the reflective component 3 and the imaging assembly 2 constitute the imaging system; F/# of the lighting system is 0.45 to 0.55 times that of the projection system. F/# of the imaging system is 0.45 to 0.55 times that of the projection system.

Specifically, the F/# of the lighting system (corresponding to the entrance pupil of the lighting system) is 0.45 to 0.55 times the F/# of the projection system. The F/# of the imaging system (corresponding to the exit pupil of the imaging system) is 0.45 to 0.55 times that of the projection system.

For example, the F/# of the imaging system is 1.23, and the ray angle of the projection system is −24° to 24°. In the lighting optical path, the ray angle is −24° to 0°, and in the imaging optical path, the ray angle is 0° to 24°. By conversion, the F/# of a lighting and imaging optical path system (the projection system includes the lighting optical path and the imaging optical path, that is, the lighting and imaging optical path system) is 2.4, the F/# of the imaging system is 1.23, and the F/# of the lighting and imaging optical path system is 0.5125 times that of the imaging system. Referring to FIG. 1, the rays L1 represent rays of the lighting optical path (from entrance pupil to the reflective component 3 of the lighting system), the reflection rays L2 represent rays of the imaging optical path (from the reflective component 3 to the exit pupil), and the triangle A represents the designed maximum exit pupil of the projection system, and the triangle A1 and the triangle A2 respectively represent the ray angle of the entrance pupil that can be accepted by the lighting optical path, and the ray angle of the exit pupil that can be accepted by the imaging optical path.

The present embodiment defines the F/# of the projection system, the F/# of the lighting optical path system, and the F/# of the imaging optical path system, in such a way that at least enables the chief ray emitted by the light source assembly 1 to be incident through the first part 211 of the first lens 21, and enables the reflected chief ray formed by being reflected by the reflective component 3 to be emergent through the second part 212 of the first lens 21.

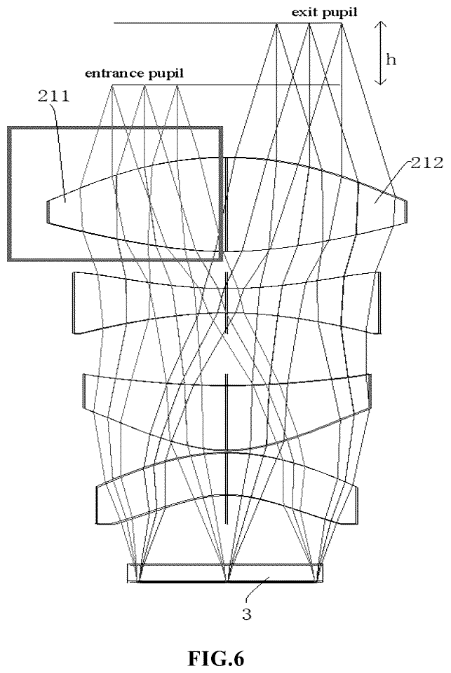

In an alternative embodiment, referring to FIGS. 1 to 6, the entrance pupil of the lighting system and the exit pupil of the imaging system are located on the same side, and the entrance pupil of the lighting system is located closer to the first lens 21 than the exit pupil of the imaging system, so as to further reduce the volume of the projection system. Referring to FIG. 6, there is a height difference H between the exit pupil and the entrance pupil.

In one embodiment, referring to FIGS. 1 to 6, the chief ray is transmitted through the first part 211 of the first lens 21 to the reflective component 3 to form the lighting optical path, the reflection chief ray is transmitted through the reflective component 3 to the second part 212 of the second lens 22 to form the imaging optical path, and the lighting optical path and the imaging optical path are arranged non-coaxially.

In the embodiment, the chief ray emitted by the light source assembly 1 is transmitted through the first part 211 of the first lens 21 to the reflective component 3 to form the lighting optical path. That is, in the lighting optical path, the chief ray is incident from the first part 211 of the first lens 21 and then transmitted in the imaging assembly 2. The reflection chief ray is transmitted through the reflective component 3 to the second part 212 of the second lens 22 to form the imaging optical path. That is, in the imaging optical path, the reflection chief ray is emergent from the second part 212 of the first lens 21, that is, the incident position of the chief ray and the emergent position of the reflection chief ray are not at the same position, that is, the chief ray is not transmitted straight in and straight out.

Therefore, the projection system provided by the present embodiment is an off-axis projection system. Although the lighting optical path and the imaging optical path share the imaging assembly 2, the lighting optical path and the imaging optical path are arranged non-coaxially. That is, both the lighting optical path and the imaging optical path are offset from the optical axis, and the lighting optical path and the imaging optical path are not overlapped.

In one embodiment, referring to FIG. 6, the first part 211 and the second part 212 of the first lens 21 have unequal curvature radii.

Under normal conditions, the chief ray is transmitted through the first part 211 of the first lens 21 to the reflective component 3 to form the lighting optical path, the reflection chief ray is transmitted through the reflective component 3 to the second part 212 of the second lens 22 to form the imaging optical path, the lighting optical path and the imaging optical path have the equal optical path lengths, and the entrance pupil of the lighting system and the exit pupil of the imaging system have the same optical characteristics. However, the selection of different architectures of the light source assembly 1 may cause the problem that he lighting optical path and the imaging optical path have unequal optical path lengths. To solve this problem, the curvature radius of the first part 211 of the first lens 21 may be set to be unequal to the curvature radius of the second part 212 of the first lens 21. That is, by setting the first part 211 and the second part 212 of the first lens 21 as lenses with different degrees of refractive power, it is possible to adjust the optical path length of the lighting optical path and that of the imaging optical path, such that the optical path length of the lighting optical path is consistent with the optical path length of the imaging optical path. For example, the first lens 21 closest to the entrance pupil of the lighting system is designed as a freeform lens, that is, the first lens 21 closest to the exit pupil of the imaging system is designed as a freeform lens.

In one embodiment, as shown in FIG. 6, the chief ray is transmitted through the first part 211 of the first lens 21 to the reflective component 3 to form the lighting optical path, and the reflection chief ray is transmitted through the reflective component 3 to the second part 212 of the first lens 21 to form the imaging optical path; when the lighting optical path has an optical path length shorter than that of the imaging optical path, the first part 211 of the first lens 21 has a curvature radius smaller than that of the second part 212 of the first lens 21.

In the embodiment, the optical path length (the entrance pupil optical path length) of the lighting optical path is shorter than the optical path length of the imaging optical path. By setting the curvature radius of the first part 211 of the first lens 21 (referring to FIG. 6, the area enclosed by the square is the first part 211) to be smaller than the curvature radius of the second part 212 of the first lens 21, it is possible to lengthen the optical path length of the lighting optical path. In particular, the curvature radius influences the focal length of the lens, which is related to the optical path length of the optical path. Therefore, it is possible to adjust the optical path length of the optical path by adjusting the parameter of the curvature radius.

In one embodiment, referring to FIGS. 1 to 6, the imaging assembly 2 includes a lens assembly arranged along the optical axis, which includes the first lens 21.

In the embodiment, the architecture of the imaging assembly 2 is defined, and the imaging assembly 2 is composed of the lens group. In the embodiment, the lenses in the lens assembly of the imaging assembly 2 are not particularly limited as long as the chief ray emitted by the light source assembly 1 can be incident through the first part 211 of the first lens 21, and the reflection chief ray can be emergent through the second part 212 of the first lens 21.

In a specific embodiment, as shown in FIGS. 1 to 6, the lens assembly further includes a second lens 22, a third lens 23 and a fourth lens 24 which are sequentially arranged along the optical axis, and the second lens 22 is disposed adjacent to the first lens 21; the first lens 21 is a biconvex lens, the second lens 22 is a biconcave lens, the third lens 23 is a concave-convex lens, and the fourth lens 24 is a convex-concave lens.

In the embodiment, in the direction from the exit pupil of the imaging assembly 2 to the reflective component 3, the lens group includes sequentially the first lens 21, the second lens 22, the third lens 23, and the fourth lens 24. The first lens 21 is a biconvex lens, the second lens 22 is a biconcave lens, the third lens 23 is a concave-convex lens, and the fourth lens 24 is a convex-concave lens. The first lens 21, the second lens 22, the third lens 23 and the fourth lens 24 are different in their ability to deflect rays, which does not influence the incidence of the chief ray and the emergence of the reflection chief ray. Therefore, the architecture of the imaging assembly 2 includes, but is not limited to, the four lenses described above.

In one embodiment, referring to FIGS. 2 to 5, the light source assembly 1 includes a light source group 11 and a light combining group 12, rays emitted from the light source group 11 are transmitted to the ray combining group 12, and the light combining group 12 transmits received rays to the first part 211 of the first lens 21.

In the embodiment, the architecture of the light source assembly 1 is defined, and the light source assembly 1 includes the light source group 11 and the light combining group 12 provided corresponding to the light source group 11. For example, the light source group 11 includes a first light source, a second light source, and a third light source. Specifically, the first light source may be a light source emitting red light, the second light source may be a light source emitting green light, and the third light source may be a light source emitting blue light. The light combining group 12 processes the rays emitted from the light source group 11, and the processed rays are incident through the first part 211 of the first lens 21.

In an alternative embodiment, the light source is not limited to LEDs, but also may be a Lamp, Laser, or the like.

In one embodiment, referring to FIGS. 2 to 5, the light combining group 12 includes a compound parabolic concentrator 123 and the light waveguide, and the light waveguide is located on a light-emergent side of the compound parabolic concentrator 123;

Alternatively, the light combining group 12 includes a total internal reflection lens 124 and the light waveguide, and the light waveguide is located on a light-emergent side of the total internal reflection lens 124.

In a specific embodiment, the light combining group includes three compound parabolic concentrators 123 arranged in different horizontal planes or three total internal reflection lenses 124 arranged in different horizontal planes;
light waveguides corresponding one-to-one with the three compound parabolic concentrators 123 or the three total internal reflection lenses 124 have unequal lengths.

In a specific embodiment, the light combining group includes three compound parabolic concentrators 123 arranged in the same horizontal plane or three total internal reflection lenses 124 arranged in the same horizontal plane;
light waveguides corresponding one-to-one with the three compound parabolic concentrators 123 or the three total internal reflection lenses 124 have equal lengths.

In a specific embodiment, referring to FIG. 2, the light combining group 12 includes a collimator 121, a light waveguide 122 and a dichroic mirror 125. The chief ray emitted by the light source group 11 passes through the collimator 121 and becomes parallel rays. The parallel rays are transmitted to the dichroic mirror 125 through the light waveguide 122, and then reflected to the first part 211 of the first lens 21 by the dichroic mirror 125. The chief ray is incident through the first part 211 of the first lens 21. In the embodiment, the light source group 11 includes three light sources, and the collimator 121 is provided corresponding to the light sources, that is, the light combining group 12 is provided with three collimators 121. The light waveguide 122 is provided corresponding to the different collimators 121, that is, the light combining group 12 is provided with three light waveguides 122. In the embodiment, the different collimators 121 are located at different positions (the collimators 121 are not provided on the same horizontal plane), and the light waveguides 122 have inconsistent lengths. Referring to FIG. 2, a first light waveguide, a second light waveguide, and a third light waveguide are arranged along the transmission direction of the rays. The length of the first light waveguide is shorter than the length of the second light waveguide, and the latter is shorter than the length of the third light waveguide.

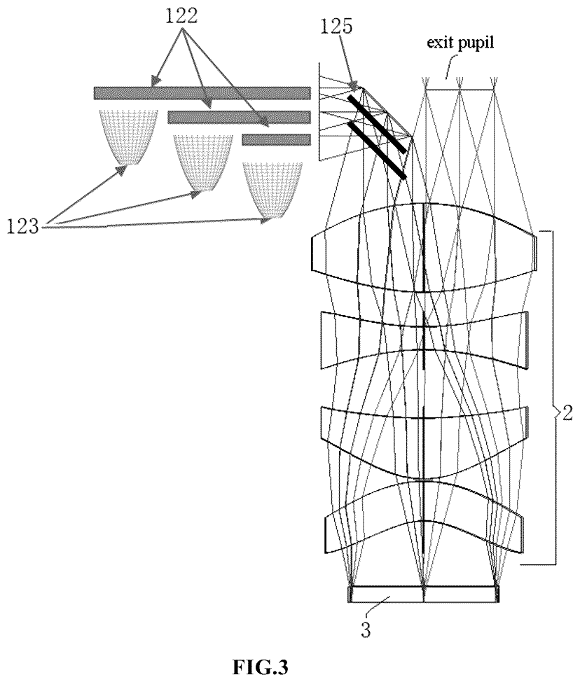

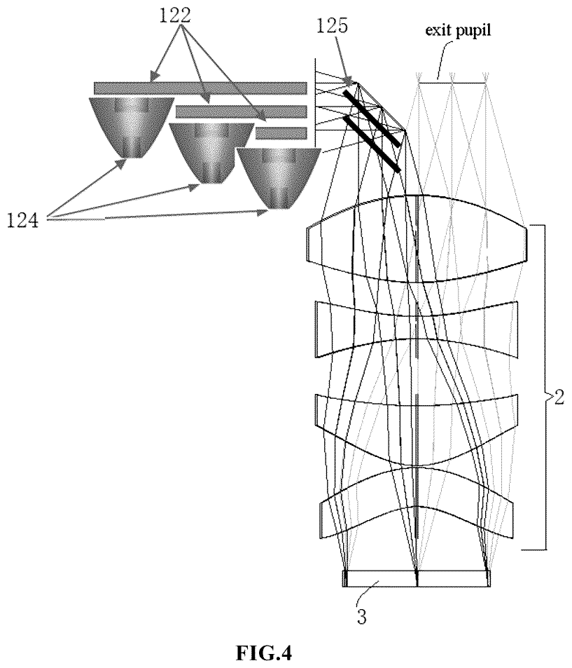

In a specific embodiment, referring to FIGS. 3 and 4, the light combining group 12 uses either the compound parabolic concentrator (CPC) 123 or the total internal reflection lens (TIR lens) 124, and by combining it with the light waveguide 122, the uniformity of the rays across the angular space of the entrance pupil may be improved. Referring to FIG. 3, the light combining group 12 includes a compound parabolic concentrator 123 (CPC), a light waveguide 122 and a dichroic mirror 125. Referring to FIG. 4, the light combining group 12 includes a total internal reflection lens 124 (TIR lens), a light waveguide 122 and a dichroic mirror 125. In the embodiment, the different collimators 121 are located at different positions (the collimators 121 are not provided on the same horizontal plane), and the light waveguide 122 have inconsistent lengths. Referring to FIGS. 3 and 4, a first light waveguide, a second light waveguide, and a third light waveguide are arranged along the transmission direction of the rays. The length of the first light waveguide is shorter than the length of the second light waveguide, and the latter is shorter than the length of the third light waveguide.

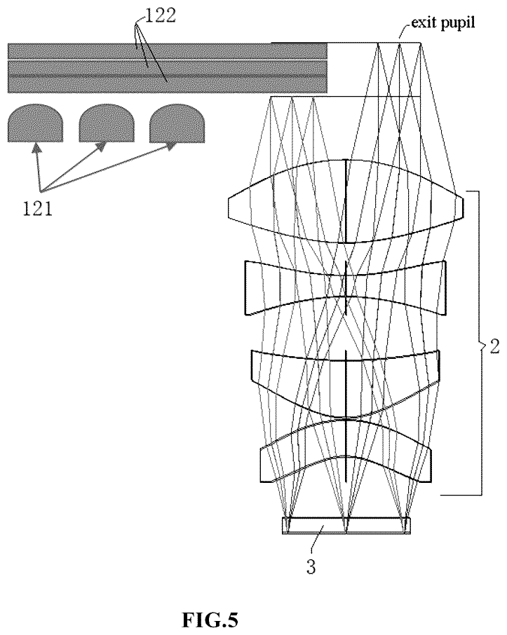

In a specific embodiment, referring to FIG. 5, the light combining group 12 includes a collimator 121 and a light waveguide 122. The collimator 121 collimates the chief ray emitted by the light source group 11 into parallel rays, and the parallel rays are directly transmitted through the light waveguide 122 to the first part 211 of the first lens 21, and the chief ray is incident through the first part 211 of the first lens 21. Referring to FIG. 5, a first light waveguide, a second light waveguide, and a third light waveguide are arranged along the transmission direction of the rays. The length of the first light waveguide is equal to both the length of the second light waveguide and the length of the third light waveguide.

It should be noted that the light combining group 12 includes, but is not limited to, the architecture described above. The light combining group 12 may also achieve the capability of combining three colors (RGB) using a light guide or a waveguide, similar to what a traditional X-cube prism does.

In accordance with a second aspect of embodiments of the present disclosure, an electronic device is provided. The electronic device includes the projection system of the first aspect. For example, the electronic device may be a projector or a lighting optical path. The projector may be applied to the fields of output display of a portable business projection, a small conference demonstration, a personal cinema, a field display projection, education and entertainment, a digital product, and the like; or the projection system may be applied to an AR device or a VR device.

The above embodiments focus on the differences between the embodiments, and the different optimization features between the embodiments may be combined to form a better embodiment as long as they are not contradictory, and in consideration of the conciseness, they will not be repeated herein.

Although the present disclosure has been described in detail in connection with some specific embodiments by way of illustration, those skilled in the art should understand that the above examples are provided for illustration only and should not be taken as a limitation on the scope of the disclosure. Those skilled in the art will appreciate that modifications may be made to the above embodiments without departing from the scope and spirit of the present disclosure. We therefore claim as our disclosure all that comes within the scope of the appended claims.

1. A projection system, comprising a light source assembly, an imaging assembly, and a reflective component; wherein
the imaging assembly comprises a first lens located near an exit pupil of the imaging assembly; the first lens has a first part and a second part, the first part and the second part being separated by an optical axis; and
the light source assembly is configured to emit rays, including—at least a chief emitted ray incident through the first part of the first lens, and then reflected by the reflective component to form reflection rays, including at least a chief reflection ray is-emergent through the second part of the first lens.

2. The projection system of claim 1, wherein the projection system comprises a lighting system and an imaging system; the light source assembly and the imaging assembly constitute the lighting system, the reflective component and the imaging assembly constitute the imaging system; F/# of the lighting system is 0.45 to 0.55 times that of the projection system.

3. The projection system of claim 1, wherein the chief emitted ray is transmitted through the first part of the first lens to the reflective component to form a lighting optical path; the chief reflection ray is transmitted through the reflective component to the second part of the first lens to form an imaging optical path; and the lighting optical path and the imaging optical path are arranged non-coaxially.

4. The projection system of claim 1, wherein the first part and the second part of the first lens have unequal curvature radii.

5. The projection system of claim 1, wherein the chief emitted ray is transmitted through the first part of the first lens to the reflective component to form a lighting optical path, and the chief reflection ray is transmitted through the reflective component to the second part of the first lens to form an imaging optical path;
when the lighting optical path has a shorter optical path length than the imaging optical path, the first part of the first lens has a smaller curvature radius than the second part of the first lens.

6. The projection system of claim 1, wherein the imaging assembly comprises a lens group arranged along the optical axis, and the lens comprises the first lens.

7. The projection system of claim 1, wherein the light source assembly comprises a light source group and a light combining group, such that rays emitted from the light source group are transmitted to the light combining group, and then transmitted by the light combining group to the first part of the first lens.

8. The projection system of claim 7, wherein the light combining group comprises a compound parabolic concentrator and a light waveguide, and the light waveguide is located on a light-emergent side of the compound parabolic concentrator; or
the light combining group comprises a total internal reflection lens and a light waveguide, and the light waveguide is located on a light-emergent side of the total internal reflection lens.

9. The projection system of claim 8, wherein the light combining group comprises three compound parabolic concentrators arranged in different horizontal planes or three total internal reflection lenses arranged in different horizontal planes; and
light waveguides corresponding respectively with the three compound parabolic concentrators or the three total internal reflection lenses have unequal lengths.

10. The projection system of claim 8, wherein the light combining group comprises three compound parabolic concentrators arranged in the same horizontal plane or three total internal reflection lenses arranged in the same horizontal plane; and
light waveguides corresponding respectively with the three compound parabolic concentrators or the three total internal reflection lenses have equal lengths.

11. An electronic device, comprising a projection system of claim 1.
